(19) United States
(12) Patent Application Publication
(10) Pub. No.: US 2010/0191867 A1
(43) Pub. Date: Jul. 29, 2010

(54) Systems and Methods for Performing Field Updates of Firmware

(75) Inventors: David William Douglas, Austin, TX (US); Jeffrey Scott Thelen, Round Rock, TX (US)

Correspondence Address: Baker Botts L.L.P, 910 Louisiana Street, One Shell Plaza, HOUSTON, TX, 77002, US

(73) Assignee: DELL PRODUCTS L.P., Round Rock, TX (US)

(21) Appl. No.: 12/361,865

(22) Filed: Jan. 29, 2009

(51) Int. Cl. G06F 3/00

(52) U.S. Cl. 710/8

(57) ABSTRACT

Systems and methods for updating firmware in a target device are disclosed. A system may include a source device, a target device, and a standardized bidirectional communication path coupling the source device to the target device. The source device is operable to verify that the target device is capable of receiving a firmware update from the source device via the standardized bidirectional communication path and communicate the firmware update to the verified target device via the standardized bidirectional communication path. The target device is operable to receive the firmware update from the source device via the standardized bidirectional communication path and perform the firmware update in the target device. The source device is further operable to validate the completion of the firmware update in the target device via the standardized bidirectional communication path.

### TECHNICAL FIELD

The present disclosure relates in general to information handling systems, and more particularly to performing field updates of firmware for information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software component(s) that may be configured to process, store, and communicate information and may include one or more computer systems, data storage systems, and networking systems.

As information handling systems become more complex, many information handling system components require greater feature integration. This integration requires the software embedded in these components (the “firmware”) to become more and more robust. As new features become available and new solutions arise, there is often a need to update the firmware in an information handling system or information handling system component. For some information handling system components, e.g., display devices and other peripherals, in order to update the resident firmware, the components must be shipped back to the manufacturer or service provider where unique interconnections and software are used to provide the relevant firmware update(s). As a result, firmware updates for such components may be unreliable and/or expensive to implement.

### SUMMARY

In accordance with the teachings of the present disclosure, the disadvantages and problems associated with performing field updates of firmware have been substantially reduced or eliminated.

In accordance with one embodiment of the present disclosure, an information handling system for updating firmware in a target device coupled to the information handling system is provided. The information handling system may include a bidirectional communication port for communicating data via a standardized bidirectional communication port for communicating data via a standardized bidirectional communication path, a processor coupled to the bidirectional communication port, and logic instructions stored in computer-readable media. The logic instructions are executable by the processor to verify that the target device is capable to receive a firmware update from the information handling system via the standardized bidirectional communication path, determine a firmware update appropriate for the verified target device, communicate the appropriate firmware update to the verified target device via the standardized bidirectional communication path such that the target device performs the communicated firmware update, and validate the completion of the performed firmware update in the target device via the standardized bidirectional communication path.

In accordance with another embodiment of the present disclosure, a method for communicating a firmware update from a source device to a target device coupled to the source device by a standardized bidirectional communication path is provided. The method may include the source device verifying that the target device is capable of receiving the firmware update from the source device via the standardized bidirectional communication path, determining a firmware update appropriate for the verified target device, communicating the appropriate firmware update from the source device to the verified target device via the standardized bidirectional communication path such that the target device performs the communicated firmware update, and validating the completion of the performed firmware update in the target device via the standardized bidirectional communication path.

In accordance with another embodiment of the present disclosure, a system for performing field updates of firmware is provided. A system may include a source device, a target device, and a standardized bidirectional communication path coupling the source device to the target device. The source device is operable to verify that the target device is capable of receiving a firmware update from the source device via the standardized bidirectional communication path, and communicate the firmware update to the verified target device via the standardized bidirectional communication path. The target device is operable to receive the firmware update from the source device via the standardized bidirectional communication path and perform the firmware update in the target device. The source device is further operable to validate the completion of the firmware update in the target device via the standardized bidirectional communication path.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an information handling system for updating firmware in a target device coupled to a source device via a standardized bidirectional communication path, in accordance with certain embodiments of the present disclosure;

FIG. 2 illustrates an example of a standardized bidirectional communications path, in accordance with certain embodiments of the present disclosure;

FIG. 3 illustrates a flow chart of an example method for updating firmware in a target device, in accordance with certain embodiments of the present disclosure;

FIG. 4 illustrates a flow chart of an example method for verifying that a target device is capable of receiving a firmware update from a source device via standardized bidirectional communication path, according to certain embodiments of the present disclosure;

FIG. 5 illustrates a flow chart of an example method for determining an appropriate firmware update and communicating that firmware update from a source device to a target device via a standardized bidirectional communication path, according to certain embodiments of the present disclosure; and

FIG. 6 illustrates a flow chart of an example method for performing a firmware update in a target device and validating that firmware update by a source device via a standardized bidirectional communication path, according to certain embodiments of the present disclosure.

### DETAILED DESCRIPTION

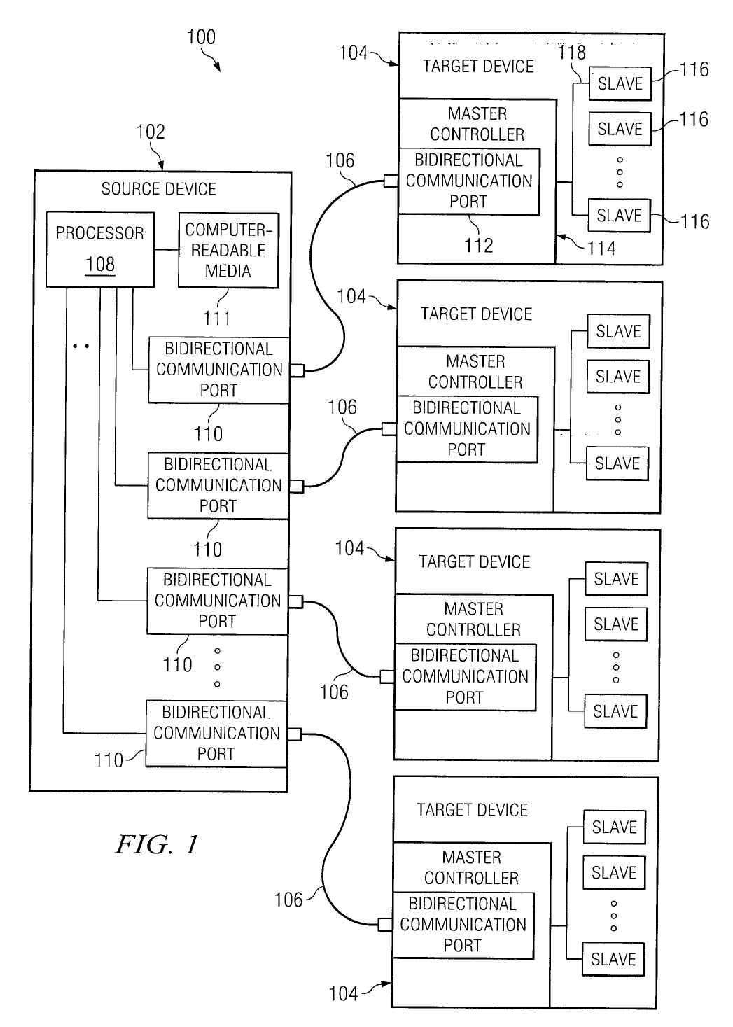

Preferred embodiments and their advantages are best understood by reference to FIGS. 1 through 6, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional component(s) or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware component(s).

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates an information handling system 100 for updating firmware in one or more target devices 104 coupled to a source device 102 via a standardized bidirectional communication path 106, in accordance with certain embodiments of the present disclosure. Source device 102 may be generally operable to verify that a target device 104 is capable of receiving a firmware update from source device 102 via standardized bidirectional communication path 106 as described in more detail below with reference to FIGS. 3-6. Once verified, source device 102 may be further operable to communicate the firmware update to the target device 104 via standardized bidirectional communication path 106.

Source device 102 is, in some embodiments, an information handling system including a processor 108, one or more bidirectional communication ports 110, computer-readable media 111, and any other suitable information handling system component(s).

Processor 108 may be any type of processing unit, whether dedicated to generalized computing or specialty processing task, e.g., graphics processing. For example, processor 108 may be an ATI Radeon HD 3470 Dual Monitor graphics card. Each bidirectional communication port 110 may be any type of communication port capable of supporting communication between processor 108 and standardized bidirectional communication path 106. For instance, bidirectional communication port 110 may be a DisplayPort port that complies with the Video Electronics Standards Association (VESA) DisplayPort standard. In some embodiments, e.g., as shown in FIG. 1, a source device 102 may include more than one bidirectional communication port 110. Each bidirectional communication port 110 may be coupled to a target device 106 via a respective standardized bidirectional communication path 106. Computer-readable media 111 may comprise any device(s) suitable to store data and/or instructions, e.g., as defined above.

Each target device 104 may be generally operable to receive a firmware update from source device 102 via standardized bidirectional communication path 106 and then perform the firmware update as described in more detail below with reference to FIGS. 3-6. In some embodiments, target device 104 is a display device or other peripheral device. For example, target device 104 may be a computer monitor, a laptop computer screen, or optical storage drive. However, target device 104 may be any device capable of receiving a firmware update from source device 102 via standardized bidirectional communication port 106 and performing that firmware update.

Target device 104 may include any number of component(s) that require a firmware update. In particular, target device 104 may include a bidirectional communication port 112. Each bidirectional communication port 112 may be any type of communication port capable of receiving data from standardized bidirectional communication path 106. For instance, bidirectional communication port 112 may be a DisplayPort port that complies with the VESA DisplayPort standard.

A target device 104 may include multiple components capable of receiving firmware updates. In some embodiments, e.g., as shown in FIG. 1, these components may be arranged in a master-slave architecture comprising a master controller 114 and one or more slave devices 116 coupled to master controller 114 via a communication path 118. Target device 104 may be further operable to identify master controller 114 and/or slave devices 116 to source device 102 via standardized bidirectional communication path 106 such that source device 102 may determine which component(s) require and/or should receive a firmware update. Target device 104 may be further operable to perform firmware update(s) received from source device 102, e.g., as described in more detail below with reference to FIGS. 3-6.

In some embodiments, master controller 114 may be a microcontroller capable of sending information to multiple slave devices 116. Each slave device 116 may be any component capable of receiving a firmware update from master controller 114, e.g., a digital-to-analog converter, switch, or another microcontroller. Communication path 118 may be an I₂C serial bus, DisplayPort bus, or any other communication path configured to support a master-slave architecture.

Standardized bidirectional communication path 106 is a communication path coupling source device 102 and target device 104. In some embodiments, standardized bidirectional communication path 106 complies with the VESA DisplayPort standard. For example, standardized bidirectional communication path 106 may be a 1, 2, or 4 lane DisplayPort cable of sufficient length to couple source device 102 to target device 104. However, standardized bidirectional communication path 106 may be an electrical bus coupling source device 102 to target device 104 in an integrated information handling system, such as a laptop computer.

In operation, source device 102 may verify that each target device 104, or one or more particular target devices 104, can receive a firmware update from source device 102 via a respective standardized bidirectional communication path 106. Standardized bidirectional communication path 106 allows a single path type to be used between source device 102 and different types of target devices 104. Once verified, source device 102 may gather information about any component(s) of target device(s) 104 that require and/or should receive a firmware update. Source device 102 may then determine an appropriate firmware update for each component of each target device 104, then communicate that update to each respective target device 104 via the respective standardized bidirectional communication path 106. After each target device 104 performs any required firmware update, source device 102 may then validate the firmware update(s) by reading information from each updated target device 104 via the respective standardized bidirectional communication path 106.

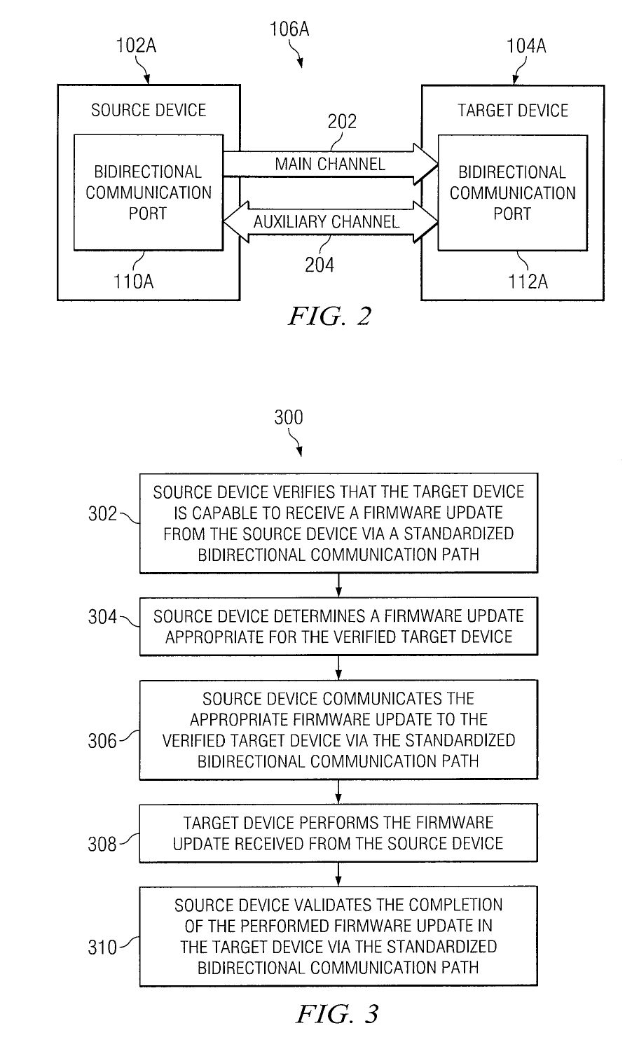

FIG. 2 illustrates an example standardized bidirectional communications path 106A connecting a source device 102A with a target device 104A, in accordance to certain embodiments of the present disclosure. In this example, standardized bidirectional communications path 106A complies with the VESA DisplayPort standard. Standardized bidirectional communications path 106A includes a bidirectional communication port 110A of source device 102A, a bidirectional communication port 112A of target device 104A, a main channel 202, and an auxiliary channel 204.

In some embodiments, main channel 202 comprises an AC-coupled, doubly-terminated differential wire pairs. Among other advantages, this may allow bidirectional communication ports 110A and 112A to have different common mode voltages. As a result, source device 102A does not require a specialized communication path for each possible type of target device 104A.

Auxiliary channel 204 may comprise an AC-coupled, doubly terminated differential wire pair. Among other advantages, this may allow bidirectional communication apart from main channel 202. Source device 102A may initiate a communication with target device 104A via auxiliary channel 204 and may read data from target device 104A, e.g., as described in more detail below with reference to FIGS. 3-6.

FIG. 3 illustrates a flow chart of an example method 300 for updating firmware in a target device 104, in accordance with certain embodiments of the present disclosure. Method 300 includes verifying a target device 104, determining a firmware update for target device 104, communicating that firmware update to target device 104 such that it performs the firmware update, and validating the completion of the firmware update.

According to one embodiment, method 300 preferably begins at step 302. Teachings of the present disclosure may be implemented in a variety of configurations of system 100. As such, the preferred initialization point for method 300 and the order of steps 302-310 comprising method 300 may depend on the implementation chosen.

At step 302, a source device 102 verifies that target device 104 is capable of receiving a firmware update from source device 102 via standardized bidirectional communication path 106. At step 304, source device 102 determines the appropriate firmware update for verified target device 104. At step 306, source device 102 communicates the firmware update to target device 104 via standardized bidirectional communication path 106. At step 308, target device 104 performs the firmware update. At step 310, source device 102 validates the completion of the firmware update in target device 104 via standardized bidirectional communication path 106.

Although FIG. 3 discloses a particular number of steps to be taken with respect to method 300, method 300 may be executed with more or fewer steps than those depicted in FIG. 3. In addition, although FIG. 3 discloses a certain order of steps comprising method 300, the steps comprising method 300 may be completed in any suitable order. For example, in the embodiment of method 300 shown, validation of the firmware update shown in step 310 does not occur until after all firmware update(s) (e.g., in the target device 104 or in multiple target devices 104 being updated) have completed in steps 306-308. However, validation of a firmware update could be completed on an update-by-update basis such that one component of target device 104 receives a firmware update, that update is performed and validated, and then the system 100 moves on to perform and validate the firmware update for another component of target device 104 or for another target device 104.

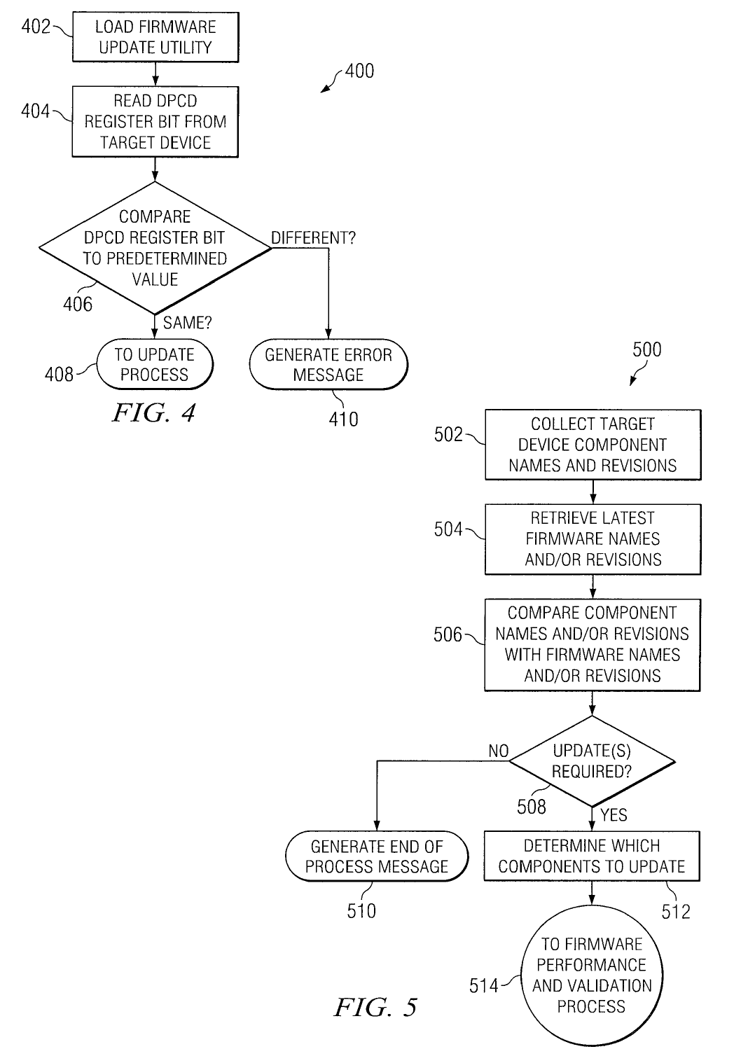

One embodiment of method 300 is described in more detail below with reference to FIGS. 4-6. In this example embodiment, each of the parts referenced in FIGS. 4-6 comply with the VESA DisplayPort standard. As noted above, teachings of the present disclosure may be implemented in a variety of configurations of system 100. As such, the initialization point for methods 400, 500, and 600 and the order of each of the steps comprising these methods may depend on the implementation chosen. Further, each of methods 400, 500, and 600 may be executed with more or fewer steps than those depicted in FIGS. 4-6.

FIG. 4 illustrates a flow chart of an example method 400 for verifying that target device 104 is capable of receiving a firmware update from source device 102 via standardized bidirectional communication path 106. Thus, method 400 corresponds generally with step 302 of method 300 shown in FIG. 3.

At step 402, a source device 102 loads a utility for updating firmware in a target device 104. Step 402 may be initiated manually by a user of source device 102 or automatically by some automated or predetermined event programmed into the source device 102. At step 404, source device 102 checks target device 104 to determine if target device 104 is capable of upgrading via standardized bidirectional communication path 106. Source device 102 may determine target device's 104 capability by reading data stored in target device 104 via standardized bidirectional communication path 106. For instance, as shown in FIG. 4, source device 102 may read a bit stored in the DisplayPort Configuration Data (DPCD) register of the target device 104 via standardized bidirectional communication path 106.

At step 406, source device 102 compares the DPCD register bit read from target device 104 to a predetermined value stored in source device 102. If the DPCD register bit value matches the predetermined value, then the method continues to step 408 to the firmware update process, e.g., as described in detail in FIG. 5 below. If the DPCD register bit value does not match the predetermined value, source device 102 generates an error message at step 410. For example, if the DPCD register bit read from target device 104 has a value of “11,” this may indicate that target device 104 is capable of upgrading via standardized communication path 106, and the method would continue to the firmware update process.

FIG. 5 illustrates a flow chart of an example method 500 for determining an appropriate firmware update and communicating that firmware update from a source device 102 to a target device 104 via a standardized bidirectional communication path 106. Method 500 generally corresponds with step 304 of method 300 shown in FIG. 3.

At step 502, source device 102 collects the names and/or revision numbers of various target device 104 component(s) via standardized bidirectional communication path 106. In some embodiments, source device 102 stores these names and/or revision numbers in its DPCD register. Step 502 may be initiated manually by a user of source device 102 or automatically by some automated or predetermined event programmed into source device 102, e.g., the end of the process represented in FIG. 4.

At step 504, source device 102 retrieves the latest firmware names and/or revisions. For example, source device 102 may retrieve this information from an internet-based service or computer-based media such as a compact disc.

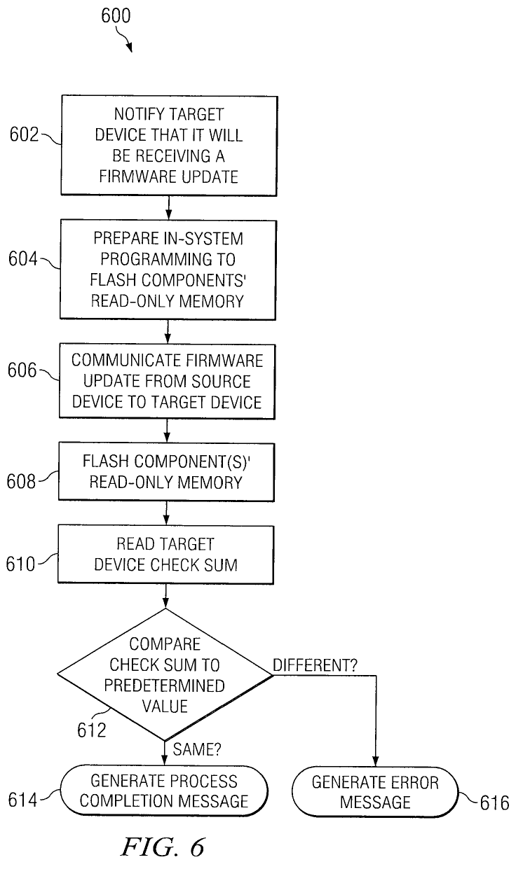

At step 506 source device 102 compares the names and/or revisions of target device 104 component(s) to the retrieved firmware names and/or revisions. At step 508, source device 102 determines whether any component(s) do not have the latest firmware revision and/or require update based at least on the comparison at step 506. If no component(s) require updating, then source device 102 generates an appropriate message at step 510. If source device 102 determines at step 508 that one or more components do require a firmware update, source device 102 determines which component(s) require a firmware update at step 512 and method 500 continues at step 514 to the firmware update performance and validation process, e.g., as described in detail in FIG. 6 below.

FIG. 6 illustrates a flow chart of an example method 600 for performing a firmware update in a target device 104 and validating that firmware update by a source device 102 via a standardized bidirectional communication path 106. Method 600 generally corresponds with steps 306 and 208 of method 300 shown in FIG. 3.

At step 602, source device 102 notifies target device 104 that certain of target device's 104 component(s) will be receiving a firmware update. At step 604, target device 104 prepares its component(s) to receive the firmware update. In some embodiments, target device 104 includes multiple components configured in a master-slave architecture including a master controller 114 and a number of slave devices 116, e.g., as discussed above with reference to FIG. 1. To prepare the slave device(s) 116 to receive the firmware update, the master controller 114 prepares its in-system programming to flash the read-only memory of the relevant slave device(s) 116.

At step 606, source device 102 communicates the firmware update to target device 104 via standardized bidirectional communication path 106. At step 608, the target device 104 performs the firmware update. Where target device 104 includes components in a master-slave architecture, master controller 114 flashes the read-only memory of the relevant slave device(s) 116.

At step 610, source device 102 reads a check sum stored in target device 104 via the standardized bidirectional communication path 106. At step 612, the source device 102 compares the check sum value to a predetermined value stored by source device 102. If the values match, then source device 102 detected no error in the firmware update(s) and the source device 102 generates an appropriate message at step 614 indicating a validated firmware update. If the values do not match, then there may have been an error in the firmware update(s) and source device 102 generates an error message at step 616.

Using the methods and systems disclosed herein, certain problems associated with field updating firmware of information handling systems in a standardized, validated manner may be improved, reduced, or eliminated. For example, the methods and systems disclosed herein allow for field updating the firmware of information handling systems and their components through the use of a standardized bidirectional communication path. In addition, to provide validation of a firmware update, such communication path may be used to read data from a target device of an information handling system.

Although the present disclosure has been described in detail, it should be understood that various changes, substitutions, and alterations can be made hereto without departing from the spirit and the scope of the disclosure as defined by the appended claims.

What is claimed is:

1. An information handling system for updating firmware in a target device coupled to the information handling system, comprising:
a bidirectional communication port for communicating data via a standardized bidirectional communication path;
a processor coupled to the bidirectional communication port; and
logic instructions stored in computer-readable media and executable by the processor to:
verify that the target device is capable to receive a firmware update from the information handling system via the standardized bidirectional communication path;
determine a firmware update appropriate for the verified target device;
communicate the appropriate firmware update to the verified target device via the standardized bidirectional communication path such that the target device performs the communicated firmware update; and
validate the completion of the performed firmware update in the target device via the standardized bidirectional communication path.

2. The system of claim 1, wherein the bidirectional communication port comprises a DisplayPort communication port.

3. The system of claim 1, wherein the target device is a display device or other peripheral device.

4. The system of claim 1, wherein the logic instructions validate the completion of the performed firmware update by:
receiving feedback at the source device from the target device via the standardized bidirectional communication path; and
determining whether to validate the firmware update based at least on the received feedback.

5. The system of claim 1, wherein the instructions validate the completion of the performed firmware update by:
reading a checksum from the target device via the standardized bidirectional communication path; and
comparing the checksum to a predetermined number.

6. The system of claim 1, wherein the logic instructions verify that the target device is capable to receive a firmware update from the information handling system via the standardized bidirectional communication path by:
checking a DPCD register bit of the target device via the standardized bidirectional communication path; and
comparing the DPCD register bit to a predetermined value.

7. A method for communicating a firmware update from a source device to a target device coupled to the source device by a standardized bidirectional communication path, the method comprising:
the source device verifying that the target device is capable to receive the firmware update from the source device via the standardized bidirectional communication path;
determining a firmware update appropriate for the verified target device;
communicating the appropriate firmware update from the source device to the verified target device via the standardized bidirectional communication path such that the target device performs the communicated firmware update; and
the source device validating the completion of the performed firmware update in the target device via the standardized bidirectional communication path.

8. The method of claim 6, wherein:
the target device includes a master controller and one or more slave devices; and
the target device performing the communicated firmware update comprises:
the master controller identifying a particular slave device that is operable to receive the firmware update via a communication path between the master controller and the particular slave device;
determining a portion of the firmware update appropriate for the particular slave device;
communicating the portion of the firmware update from the master controller to the particular slave device; and
the particular slave device performing the portion of the firmware update.

9. The method of claim 7, wherein the communication path between the master controller and the particular slave device comprises an I²C bus.

10. The method of claim 6, wherein the determination of the firmware update appropriate for the verified target device is made by the source device.

11. The method of claim 6, wherein the standardized bidirectional communication path comprises a DisplayPort communication path.

12. The method of claim 6, wherein the target device comprises a display device or other peripheral device.

13. The method of claim 6, wherein the source device verifies that the target device is capable to receive the firmware update from the source device via the standardized bidirectional communication path by:
checking a DPCD register bit of the target device via the bidirectional communication path; and
comparing the DPCD register bit to a predetermined value.

14. The method of claim 6, wherein the source device validates the completion of the performed firmware update by:
reading a check sum from the target device via the standardized bidirectional communication path; and
comparing the check sum to a predetermined number.

15. The method of claim 6, wherein the source device, the target device, and the standardized bidirectional communication path are part of a physically integrated computing device.

16. An information handling system for updating firmware in a target device, comprising:
a source device;
a target device; and
a standardized bidirectional communication path coupling the source device to the target device;
wherein the source device is operable to:
verify that the target device is capable of receiving a firmware update from the source device via the standardized bidirectional communication path; and
communicate the firmware update to the verified target device via the standardized bidirectional communication path;
the target device is operable to:
receive the firmware update from the source device via the standardized bidirectional communication path; and
perform the firmware update in the target device; and
the source device is further operable to validate the completion of the firmware update in the target device via the standardized bidirectional communication path.

17. The system of claim 15, wherein the target device comprises:
a master controller; and
one or more slave devices, wherein:
the master controller is operable to:
identify a particular slave device coupled to the master controller;
receive the firmware update from the source device via the standardized bidirectional communication path; and
communicate a portion of the firmware update appropriate for the particular slave device to the particular slave device; and
the particular slave device is operable to:
receive the portion of the firmware update; and
perform the portion of the firmware update.

18. The system of claim 16, wherein the particular slave device is coupled to the master controller via an I²C serial bus.

19. The system of claim 15, wherein the source device, the target device, and the standardized bidirectional communication path are part of a physically integrated computing device.

20. The system of claim 15, wherein the standardized bidirectional communication path is a DisplayPort path.

21. The system of claim 15, wherein the target device is a display device or other peripheral device.

22. The system of claim 15, wherein the source device verifies that the target device is capable of receiving a firmware update from the source device via the standardized bidirectional communication path by:
checking a DPCD register bit of the target device via the bidirectional communication path; and
comparing the DPCD register bit to a predetermined value.

23. The system of claim 15, wherein the source device validates the completion of the firmware update in the target device via the standardized bidirectional communication path by:
reading a checksum from the target device via the bidirectional communication port; and
comparing the checksum to a predetermined number.
